(19) United States
(12) Patent Application Publication
(10) Pub. No.: US 2009/0014373 A1
(43) Pub. Date: Jan. 15, 2009

(54) Magazine for Separation Columns

(75) Inventor: Konstantin CHOIKHET, Karlsruhe (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/212,669

(22) Filed: Sep. 18, 2008

(51) Int. Cl. G01N 30/00; G01N 30/60

(52) U.S. Cl. 210/198.2; 96/106

(57) ABSTRACT

A separation unit comprising a magazine unit with a magazine is described. The magazine comprises a plurality of pockets, each pocket being adapted for accommodating a separation column for separating compounds of a fluid sample. The magazine unit is adapted for moving any of the pockets to a structural component, wherein a pocket and the structural component are adapted for complementing one another to form a column compartment.

### BACKGROUND ART

The present invention relates to a separation unit and to a separation system comprising a separation unit. The present invention further relates to a method for installing a separation column in a separation unit, and to a method for exchanging a separation column in a separation unit.

International Patent Application WO 01/06166 A2 relates to compression connectors that can form a seal by a force applied in a linear motion, without applying a torque.

U.S. Pat. No. 4,451,365 relates to a clamping and sealing apparatus for use with separation columns, i.e., chromatography columns. Sealing elements having sealing means extending therefrom are provided at each end of a column with at least one being movable in an axial direction and controlled by pressure generating means. The sealing members are shaped corresponding to the ends of the column to fit flush against the column and to provide a seal when actuated by the pressure generating means.

### DISCLOSURE

It is an object of the invention to provide an improved separation unit with a plurality of separation columns. The object is solved by the independent claim(s). Further embodiments are shown by the dependent claim(s).

A separation unit according to embodiments of the present invention comprises a magazine unit with a magazine comprising a plurality of pockets, each pocket being adapted for accommodating a separation column for separating compounds of a fluid sample. The magazine unit is adapted for moving any of the pockets to a structural component, wherein a pocket and the structural component are adapted for complementing one another to form a column compartment.

In the magazine, a plurality of different separation columns can be stored. For this purpose, the magazine comprises mechanical features adapted for accommodating the separation columns. In the following, only those mechanical features that are adapted for accommodating a separation column will be referred to as “pockets”.

The separation columns contained in the pockets of the magazine may e.g. have different dimensions, and they may e.g. be filled with different packing materials. From these separation columns, a user may select the separation columns that seems to be appropriate for analyzing a sample.

Next, the pocket containing the selected separation column is moved to the structural component. The structural component and the pocket containing the selected separation column both enclose the selected separation column and form a column compartment for the selected separation column. Thus, by moving the pocket with the selected separation column to the structural component, a column compartment for the selected separation column is formed. Said column compartment may for example be used for bringing the selected separation column to a desired temperature before the separation is performed.

The structural component and the pockets of the magazine are realized as complementary parts that are adapted for forming a column compartment for the selected column. Thus, a suitable column compartment for the selected separation column is automatically formed when the selected separation column is moved to the structural component, with the selected separation column being contained in said column compartment. According to embodiments of the present invention, it is not necessary to provide a dedicated column compartment for each of the separation columns.

According to a preferred embodiment, the separation unit comprises a fluid supply member adapted for establishing a fluid-tight fluidic connection with an inlet of a separation column contained in the column compartment. According to another preferred embodiment, the separation unit comprises a fluid discharge member adapted for establishing a fluid-tight fluidic connection with an outlet of a separation column contained in the column compartment. The fluid supply member and the fluid discharge member are adapted for establishing fluidic contact with the separation column. For example, via the fluid supply member, solvent and sample may be supplied to the separation column. Via the fluid discharge member, the outlet of the separation column may for example be connected to a detection unit for analyzing the compounds of a sample.

In a preferred embodiment, the structural component is located adjacent to the magazine. Preferably, the structural component extends along the direction of the pockets of the magazine. In a preferred embodiment, the structural component is located external to the magazine. However, the structural component may as well be located in the interior of the magazine.

According to a preferred embodiment, when a selected pocket with a separation column contained therein is moved to the structural component, the pocket and the structural component complement one another and form an integral column compartment, with the separation column being contained in said column compartment. The separation column is enclosed by the pocket and the structural component. Preferably, the magazine unit is adapted for moving a selected pocket containing a separation column to a predefined position relative to the structural component. At this predefined position, fluidic contact with the inlet and the outlet of the separation column may e.g. be established.

According to a preferred embodiment, the magazine unit comprises a drive unit adapted for driving the magazine to a plurality of different positions relative to the structural component. By controlling the drive unit, the task of exchanging a separation column by another separation column can be performed automatically.

According to a preferred embodiment, the column compartment is a thermostatted column compartment. For example, when a selected one of the pockets with a separation column contained therein is moved to the structural component, the structural component and the selected pocket of the magazine are adapted for forming a thermostatted column compartment, with the separation column being contained in said thermostatted column compartment. When analyzing a given sample, it may be desirable to bring the selected separation column to a predefined temperature that yields the best results. For different samples, different temperatures may be appropriate for performing the separation. Therefore, according to a preferred embodiment, the column compartment is implemented as a thermostatted column compartment that allows keeping the selected separation column at any desired temperature. Preferably, the structural component comprises a temperature unit adapted for keeping a separation column contained in the column compartment at a predefined temperature. In a preferred embodiment, the structural component comprises a countercurrent heat exchanger adapted for keeping a separation column contained in the column compartment at a predefined temperature. Further preferably, the fluid supply member is fluidically connected with a temperature unit adapted for bringing a fluid supplied to the separation column to a predefined temperature.

According to a preferred embodiment, at least some of the separation columns comprise protection covers at its respective ends. Thus, evaporation of liquids contained in the separation columns can be avoided. According to a preferred embodiment, the separation unit comprises a mechanism for automatically opening the protection covers of a separation column when the separation column is moved to the structural component. According to an alternatively preferred embodiment, at least some of the pockets comprise protection covers for protecting a separation column contained therein.

According to a preferred embodiment, the magazine is realized as a rotatable drum adapted for being rotated around an axis of rotation. A rotatable drum is capable of storing a large number of separation columns. Any of the separation columns stored in the rotatable drum can be selected and moved to the structural component by rotating the rotatable drum to a corresponding angular position.

In a preferred embodiment, the rotatable drum comprises a plurality of pockets, each pocket being adapted for accommodating a separation column, with the pockets of the rotatable drum being oriented in the direction of the axis of rotation.

According to an alternatively preferred embodiment, the magazine is adapted for being moved in a linear direction relative to the structural component.

According to a preferred embodiment, the separation unit comprises an actuation mechanism adapted for establishing fluid-tight fluidic connections between a fluid supply member and an inlet of a separation column, and between an outlet of a separation column and a fluid discharge member. Preferably, when a selected pocket with a separation column contained therein is moved to the structural component, the actuation mechanism is adapted for automatically establishing the fluid-tight fluidic connections between the fluid supply member and the inlet of the separation column and between the outlet of the separation column and the fluid discharge member.

According to a preferred embodiment, the fluidic connection between the fluid supply member and the inlet of a separation column is realized with a needle and a needle port, wherein the actuation mechanism is adapted for pressing the needle against the needle port. Further preferably, the fluidic connection between the outlet of a separation column and the fluid discharge member is realized with a needle and a needle port, wherein the actuation mechanism is adapted for pressing the needle against the needle port. According to these embodiments, fluidic connections to the inlet and the outlet of a separation column are established by pressing a needle against a corresponding needle port. Thus, it is possible to set up fluid-tight fluidic connections to the inlet and the outlet of a selected separation column. Even at pressures of several hundred bar or more, fluid-tight fluidic connections can be established. Furthermore, a fluidic connection between a needle and a needle seat can be set-up and disconnected quickly. For this reason, a connection between a needle and a needle seat is well-suited for setting up and disconnecting fluidic connections with a separation column.

A separation system according to embodiments of the present invention comprises a separation unit as described above. The separation system may further comprise one or more of the following components: a mobile phase drive, preferably a pumping system, adapted to drive a mobile phase through the separation system, a sample injector adapted to introduce a fluid sample into a mobile phase, a collection unit adapted to collect separated compounds of the fluid sample, a data processing unit adapted to process data received from the separation system, a flow cell adapted for guiding at least a portion of a stimulus signal through an eluate or a mobile phase, a detection unit adapted for determining a property of an eluate or of a mobile phase.

In a preferred embodiment, the separation system is a liquid chromatography system. In the magazine of the separation unit, a plurality of different liquid chromatography columns may be accommodated. Thus, it is possible to find a liquid chromatography column that is best suited for analyzing a given sample, or to use a plurality of different columns for performing a more comprehensive analysis.

According to embodiments of the present invention, a method for installing a separation column in a separation unit is provided. The separation unit comprises a magazine unit with a magazine comprising a plurality of pockets, each pocket being adapted for accommodating a separation column, and a structural component located adjacent to the magazine and extending along the direction of the pockets of the magazine. The magazine unit is adapted for moving the magazine to different positions relative to the structural component. The method comprises moving the magazine in a way that a selected pocket containing a separation column is moved to the structural component, wherein the selected pocket and the structural component complement one another to form a column compartment, with the separation column being contained in the column compartment.

In a preferred embodiment, the method further comprises establishing a fluid-tight fluidic connection between a fluid supply member and an inlet of the separation column. Further preferably, the method comprises establishing a fluid-tight fluidic connection between a fluid discharge member and an outlet of the separation column.

Furthermore, according to embodiments of the present invention, a method for exchanging a separation column in a separation unit is provided. The separation unit comprises a magazine unit with a magazine comprising a plurality of pockets, each pocket being adapted for accommodating a separation column, and a structural component located adjacent to the magazine and extending along the direction of the pockets of the magazine. The magazine unit is adapted for moving the magazine to different positions relative to the structural component. The method comprises repositioning the magazine relative to the structural component in a way that a first separation column is removed and a selected pocket containing a second separation column is moved to the structural component, wherein the selected pocket and the structural component complement one another to form a column compartment, with the second separation column being contained in said column compartment.

In a preferred embodiment, the method further comprises disconnecting a fluidic connection between a fluid supply member and an inlet of the first separation column. Further preferably, the method comprises disconnecting a fluid-tight fluidic connection between a fluid discharge member and an outlet of the first separation column.

According to a further preferred embodiment, the method comprises establishing a fluid-tight fluidic connection between a fluid supply member and an inlet of the second separation column. Further preferably, the method comprises establishing a fluid-tight fluidic connection between a fluid discharge member and an outlet of the second separation column.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied for controlling the operation of the magazine unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a separation system for separating compounds of a sample;

FIG. 2 depicts a separation unit according to the prior art;

FIG. 3 shows a first embodiment of a separation unit according to the present invention, with the magazine being realized as a rotatable drum;

FIG. 4 shows two different ways for establishing fluidic connections with a separation column;

FIG. 5 shows a second embodiment of a separation unit according to the present invention, with the separation columns being located inside a rotatable magazine; and

FIG. 6 shows a third embodiment of a separation unit according to the present invention, whereby the magazine is adapted for performing a linear movement.

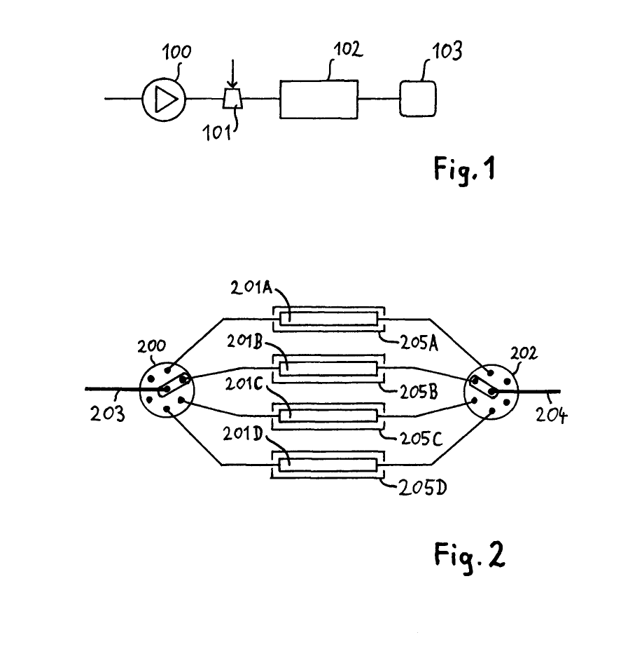

FIG. 1 shows a separation system for separating compounds of a given sample. The separation system comprises a solvent supply unit 100 adapted for supplying a flow of solvent, and a sample injection unit 101 for supplying a fluid sample to the separation flow path. The separation system further comprises a separation device 102 located downstream of the sample injection unit 101. The separation device 102 is adapted for separating the sample's various compounds. The separation device 102 may for example be a separation column filled with some kind of packing material. The outlet of the separation device 102 is fluidically connected with a detection unit 103 for detecting the sample's compounds.

When analyzing the composition of a given sample, it may be helpful to utilize different types of separation columns, in order to find out which type of separation column yields the best results. For example, for obtaining an optimum measurement result, one may try different separation columns filled with different packing materials and having different geometries. Hence, for determining a separation column that yields the best results, a device for selecting one out of a plurality of different separation columns would be helpful.

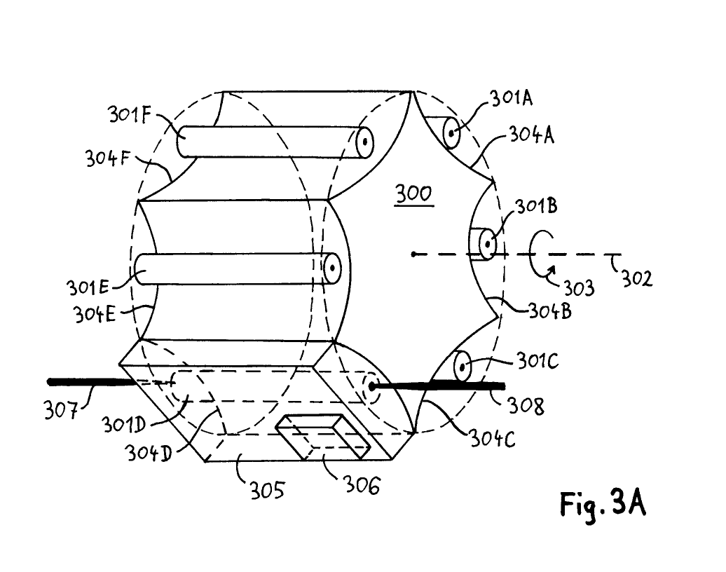

FIG. 2 shows a prior art separation unit comprising a plurality of separation columns. The separation unit comprises a first column selection valve 200, four separation columns 201A to 201D, and a second column selection valve 202. The first column selection valve 200 is adapted for connecting an inlet 203 with an inlet of a selected separation column, for example with the inlet of the separation column 201B. Similarly, the second column selection valve 202 is adapted for connecting the outlet of the selected separation column, for example the outlet of the separation column 201B, with an outlet 204 of the separation unit.

When performing a sample separation, it may be necessary to bring the selected separation column to a temperature of for example between 60° C. and 100° C. However, it is not a good idea to place all the column compartments 201A to 201D in one common thermostatted column compartment, because the permanent exposure of the separation columns to a temperature in a range between 60° C. and 100° C. may give rise to a fast degradation of the separation columns. For this reason, it can be advantageous to provide separate column compartments 205A to 205D for each of the separation columns 201A to 201D, with the temperature in each of the thermostatted column compartments 205A to 205D being controlled independently. However, implementing a separation unit of the type shown in FIG. 2 is quite expensive, because the plurality of separately temperature-controlled column compartments 205A to 205D and the column selection valves 200 and 202 contribute significantly to the total cost of the system.

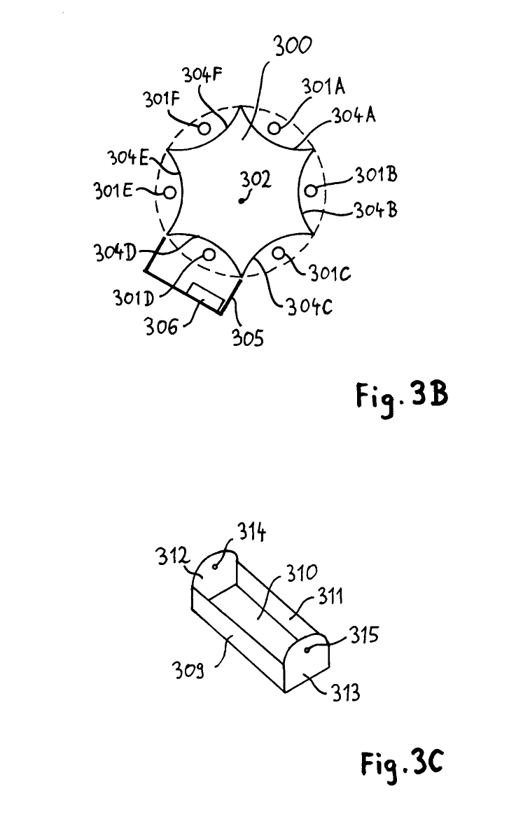

According to embodiments of the present invention, a different solution for a separation unit comprising several columns is provided. FIG. 3A shows a first embodiment of a separation unit according to the present invention. The separation unit comprises a magazine 300 adapted for holding a plurality of separation columns 301A to 301F. The magazine 300 is realized as a rotatable drum that may be rotated around an axis of rotation 302, as indicated by arrow 303. The rotatable drum comprises six recesses 304A to 304F that extend along the outer surface of the rotatable drum. Each of the recesses 304A to 304F is adapted for accommodating one of the separation columns 301A to 301F. The separation unit further comprises an external casing 305 located adjacent to the magazine 300. The external casing 305 extends along the outer surface of the rotatable drum, whereby the dimensions of the external casing 305 match with the dimensions of the recesses 304A to 304F. When the magazine 300 is rotated in a way that a selected one of the recesses 304A to 304F is positioned directly above the external casing 305, the selected recess 304D and the external casing 305 complement one another and form an integral column department for a selected separation column, e.g. for the separation column 301D. The external casing 305 is covered by the corresponding recess 304D. Thus, the selected separation column 304D is enclosed both by the recess 304D and the external casing 305.

Preferably, the column compartment comprises a temperature unit 306 adapted for keeping the column compartment at a predefined temperature. For example, the column compartment may be implemented as a thermostatted column compartment, with the temperature unit 306 being controlled in a way that the column compartment is permanently kept at a temperature that is most suitable for effectively separating a given sample. For example, the temperature in the thermostatted column compartment may be adjusted dependent on the type of sample that is being analyzed. For example, for a sample comprising heat-sensitive species, the temperature must not exceed a predefined limit.

For including the selected separation column 301D into the separation flow path, the separation unit comprises a fluid supply member 307 that is operative to establish a fluidic contact with the inlet of the separation column 301D. Via the fluid supply member 307, both solvent and sample may be supplied to the separation column 301D. The system further comprises a fluid discharge member 308 that is operative to establish a fluidic connection with the outlet of the separation column 301D. Via the fluid discharge member 308, the outlet of the separation column 301D may for example be fluidically connected with a detection unit.

FIG. 3B shows a cross section of the magazine 300 and the external casing 305. It can be seen that each of the recesses 304A to 304F is adapted for accommodating a separation column 301A to 301F. The magazine may be rotated around the axis of rotation 302, and thus, any of the recesses 304A to 304F may be rotated to the external casing 305. A respective recess 304D and the external casing 305 together form a column compartment, with the selected separation column 301D being contained in said column compartment. For keeping the selected separation column 301D at a desired temperature, the column compartment comprises a temperature unit 306.

FIG. 3C gives a view of the external casing 305, which comprises a front face 309, a bottom face 310, a rear face 311 and two side faces 312, 313. The side face 312 comprises a first cut-out 314 for the fluid supply member 307, and the side face 313 comprises a second cut-out 315 for the fluid discharge member 308. If any of the recesses 304A to 304F of the magazine 300 is rotated towards the external casing 305, said recess will act as a top cover of the external casing 305. In this regard, the external casing 305 and the recesses 304A to 304F are realized as complementary parts.

For preventing evaporation of liquid contained in any of the separation columns 301A to 301F, the respective inlets and outlets of the separation columns 301A to 301F may comprise protection covers. Furthermore, the external casing 305 may e.g. comprise a mechanism for automatically opening the protection covers of a separation column when said separation column is rotated to the external casing 305.

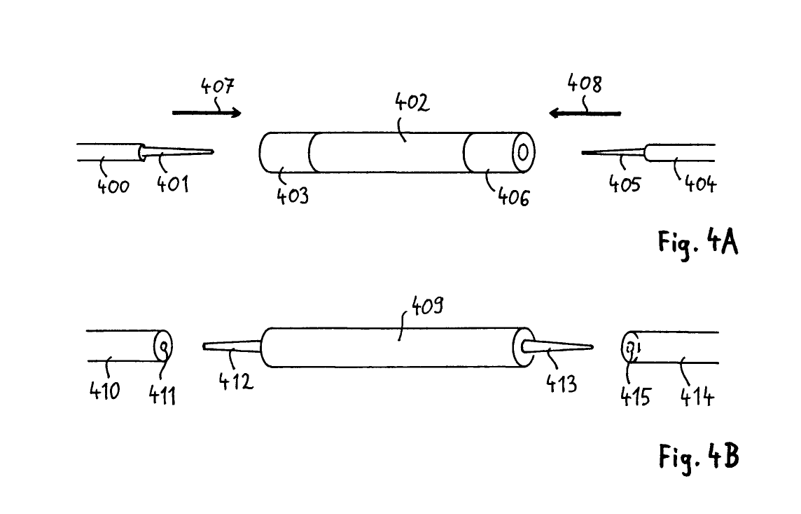

In FIGS. 4A and 4B, it is shown how fluidic connections to a separation column may be established via needles and needle ports. In the example shown in FIG. 4A, a fluid supply member 400 is equipped with a needle 401, and the inlet of the separation column 402 comprises a corresponding needle seat 403. In the same way, the fluid discharge member 404 is equipped with a needle 405, and the outlet of the separation column 402 comprises a corresponding needle seat 406. For establishing fluidic contact with the separation column 402, both the needle 401 and the needle 405 are driven towards the corresponding needle ports 403 and 406, as indicated by arrows 407 and 408. To accomplish fluid-tight fluidic connections, the drive mechanism for the needles 401 and 405 may be adapted for tightly pressing the needles 401, 405 against the needle seats 403 and 406.

For replacing the separation column 402 by a different separation column, the needles 401 and 405 are removed from the needle seats 403, 406, the magazine is rotated to a different position, and then, the needles 401, 405 are driven towards the needle seats of the new separation column.

In FIG. 4B, an alternative embodiment for establishing fluidic connections with a separation column 409 is shown. In this embodiment, the fluid supply member 410 is equipped with a needle port 411, and the inlet of the separation column 409 comprises a needle 412. Similarly, the outlet of the separation column 409 is equipped with a needle 413, and the fluid discharge member 414 comprises a corresponding needle port 415. By pressing both the needle port 411 and the needle port 415 against the corresponding needles 412, 413, the separation column 409 may be fluidically connected to the separation flow path.

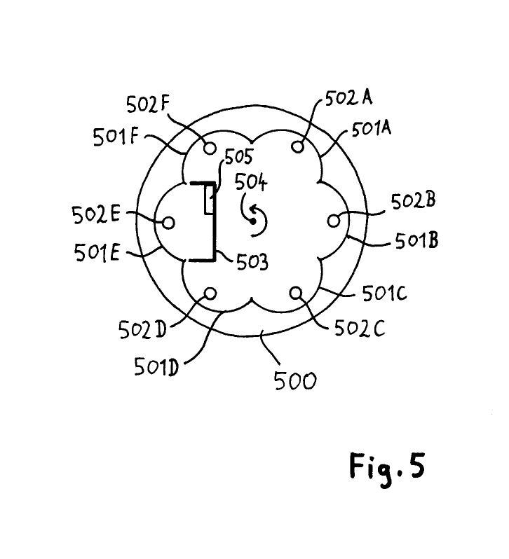

FIG. 5 shows an alternative embodiment for realizing a separation unit, whereby the magazine 500 is implemented as a rotatable cylinder. In contrast to the embodiment shown in FIGS. 3A to 3C, the recesses 501A to 501F for accommodating separation columns 502A to 502F are located in the interior of the rotatable cylinder. The system shown in FIG. 5 further comprises an internal member 503 that is located in the interior of the rotatable cylinder. By rotating the magazine 500 around the axis of rotation 504, any of the recesses 501A to 501F may be moved to a position next to the internal member 503. There, the respective recess, for example the recess 501E, forms a column compartment together with the internal member 503, with the selected separation column being contained in said column compartment. Furthermore, the internal member 503 may comprise a temperature unit 505 for bringing the column compartment to a desired temperature.

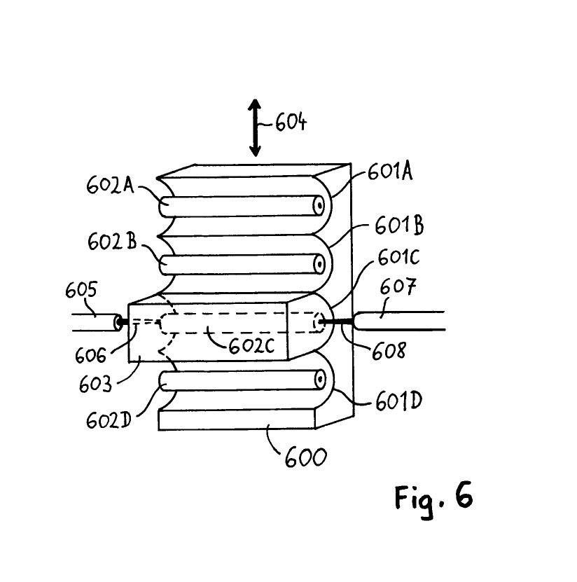

In FIG. 6, another embodiment of a separation unit is shown. The separation unit comprises a magazine 600 that is realized as a rectangular plate comprising a plurality of recesses 601A to 601D arranged in parallel. Each of the recesses 601A to 601D is adapted for accommodating a separation column 602A to 602D. The separation unit further comprises an external casing 603 that is located adjacent to the magazine 600. In contrast to the embodiments shown in FIGS. 3 and 5, in which the magazine has been adapted for performing a rotary movement, the magazine 600 shown in FIG. 6 is adapted for performing a linear movement relative to the external casing 603. As indicated by arrow 604, the magazine 600 may be moved both in the upward and downward direction. Thus, any one of the recesses 601A to 601D may be moved to a position next to the external casing 603. For example, in FIG. 6, the recess 601C containing the separation column 602C has been moved to the external casing 603, whereby the recess 601C and the external casing 603 complement one another and form an integral column compartment for the separation column 602C.

For establishing fluidic connections with the separation column 602C, the separation unit may comprise a fluid supply member 605 with a needle 606 and a fluid discharge member 607 with a needle 608. By pressing the needles 606, 608 against the corresponding needle ports of the separation column 602C, the separation column 602C may be fluidically connected to the separation flow path. The column compartment formed by the external casing 603 and the recess 601C may be realized as a thermostatted column compartment that is adapted for keeping the separation column 602C at a predefined temperature. For this purpose, the column compartment may comprise a temperature unit.

From FIG. 6, it can be seen that the external casing 603 and the respective recess 601C enclose the separation column 602C, with the separation column 602C being fixed in the recess 601C. The external casing 603 and the recesses 601A to 601D are realized as complementary parts. In particular, the dimensions of the external casing 603 and of the recesses 601A to 601D are chosen such that they match.

1. A separation unit comprising
a magazine unit with a magazine comprising a plurality of pockets, each pocket being adapted for accommodating a separation column for separating compounds of a fluid sample,
wherein the magazine unit is adapted for moving any of the pockets to a structural component, wherein a pocket and the structural component are adapted for complementing one another to form a column compartment.

2. The separation unit of claim 1, further comprising at least one of:
a fluid supply member adapted for establishing a fluid-tight fluidic connection with an inlet of a separation column contained in the column compartment;
a fluid discharge member adapted for establishing a fluid-tight fluidic connection with an outlet of a separation column contained in the column compartment;
the structural component is located adjacent to the magazine;
the structural component extends along the direction of the pockets of the magazine;
the structural component is located external to the magazine;
the structural component is in direct contact with the exterior wall of the magazine;
when a selected pocket with a separation column contained therein is moved to the structural component, the pocket and the structural component complement one another and form an integral column compartment, with the separation column being contained in said column compartment;
when a selected pocket is moved to the structural component, a separation column contained in the selected pocket is introduced to the column compartment formed by the selected pocket and the structural component;
the magazine unit is adapted for moving a selected pocket containing a separation column to a predefined position relative to the structural component;
the structural component comprises a cut-out, and the magazine unit is adapted for positioning a pocket containing a separation column next to the cut-out of the structural component.

3. The separation unit of claim 1, further comprising at least one of:
the magazine unit comprises a drive unit adapted for driving the magazine to a plurality of different positions relative to the structural component;
when a selected one of the pockets with a separation column contained therein is moved to the structural component, the structural component and the selected pocket of the magazine are adapted for forming a thermostatted column compartment, with the separation column being contained in said thermostatted column compartment;
the column compartment is a thermostatted column compartment;
the column compartment is a thermostatted column compartment adapted for keeping a separation column at a predefined temperature;
the structural component comprises a temperature unit adapted for keeping a separation column contained in the column compartment at a predefined temperature;
the structural component comprises a countercurrent heat exchanger adapted for keeping a separation column contained in the column compartment at a predefined temperature;
the fluid supply member is fluidically connected with a temperature unit adapted for bringing a fluid supplied to the separation column to a predefined temperature;
at least some of the separation columns comprise protection covers at its respective ends;
at least some of the separation columns comprise protection covers at its respective ends, and the separation unit comprises a mechanism for automatically opening the protection covers of a separation column when the separation column is moved to the structural component;
at least some of the pockets comprise protection covers for protecting a protection column contained therein.

4. The separation unit of claim 1, further comprising at least one of:
the magazine is realized as a rotatable drum adapted for being rotated around an axis of rotation;
the magazine is realized as a rotatable drum adapted for being rotated around an axis of rotation, the rotatable drum comprising a plurality of pockets, each pocket being adapted for accommodating a separation column;
the magazine is realized as a rotatable drum adapted for being rotated around an axis of rotation, the rotatable drum comprising a plurality of pockets, each pocket being adapted for accommodating a separation column, with the pockets of the rotatable drum being oriented in the direction of the axis of rotation;
the magazine is realized as a rotatable drum adapted for being rotated around an axis of rotation, wherein by rotating the rotatable drum, a selected pocket is moved to the structural component.

5. The separation unit of claim 1, wherein the magazine is adapted for being moved in a linear direction relative to the structural component.

6. The separation unit of claim 1, further comprising an actuation mechanism adapted for establishing fluid-tight fluidic connections between a fluid supply member and an inlet of a separation column, and between an outlet of a separation column and a fluid discharge member.

7. The separation unit of the preceding claim, further comprising at least one of:
when a selected pocket with a separation column contained therein is moved to the structural component, the actuation mechanism is adapted for automatically establishing the fluid-tight fluidic connections between the fluid supply member and the inlet of the separation column and between the outlet of the separation column and the fluid discharge member;
the fluidic connection between the fluid supply member and the inlet of a separation column is realized with a needle and a needle port, wherein the actuation mechanism is adapted for pressing the needle against the needle port;
the fluidic connection between the outlet of a separation column and the fluid discharge member is realized with a needle and a needle port, wherein the actuation mechanism is adapted for pressing the needle against the needle port.

8. A separation system comprising
a separation unit according to claim 1, and
a mobile phase drive, preferably a pumping system, adapted to drive a mobile phase through the separation column of the separation unit.

9. The separation system of the preceding claim, further comprising at least one of:
a sample injector adapted to introduce a fluid sample into a mobile phase;
a collection unit adapted to collect separated compounds of the fluid sample;
a data processing unit adapted to process data received from the separation system;
a flow cell adapted for guiding at least a portion of a stimulus signal through an eluate or a mobile phase;
a detection unit adapted for determining a property of an eluate or of a mobile phase.

10. The separation unit of claim 8, wherein the separation system is a liquid chromatography system.

11. A method for installing a separation column in a separation unit, the separation unit comprising a magazine unit with a magazine comprising a plurality of pockets, each pocket being adapted for accommodating a separation column, and a structural component located adjacent to the magazine and extending along the direction of the pockets of the magazine, the magazine unit being adapted for moving the magazine to different positions relative to the structural component, the method comprising
moving the magazine in a way that a selected pocket containing a separation column is moved to the structural component, wherein the selected pocket and the structural component complement one another to form a column compartment, with the separation column being contained in the column compartment.

12. The method of the preceding claim, further comprising at least one of:
establishing a fluid-tight fluidic connection between a fluid supply member and an inlet of the separation column;
establishing a fluid-tight fluidic connection between a fluid discharge member and an outlet of the separation column.

13. A method for exchanging a separation column in a separation unit, the separation unit comprising a magazine unit with a magazine comprising a plurality of pockets, each pocket being adapted for accommodating a separation column, and a structural component located adjacent to the magazine and extending along the direction of the pockets of the magazine, the magazine unit being adapted for moving the magazine to different positions relative to the structural component, the method comprising
repositioning the magazine relative to the structural component in a way that a first separation column is removed and a selected pocket containing a second separation column is moved to the structural component, wherein the selected pocket and the structural component complement one another to form a column compartment, with the second separation column being contained in said column compartment.

14. The method of the preceding claim, further comprising at least one of:
disconnecting a fluidic connection between a fluid supply member and an inlet of the first separation column;
disconnecting a fluid-tight fluidic connection between a fluid discharge member and an outlet of the first separation column;
establishing a fluid-tight fluidic connection between a fluid supply member and an inlet of the second separation column;
establishing a fluid-tight fluidic connection between a fluid discharge member and an outlet of the second separation column.

15. A software program or product, preferably stored on a data carrier, for controlling or executing the method of claim 11 or 13, when run on a data processing system such as a computer.
